(19) United States
(12) Patent Application Publication
(10) Pub. No.: US 2012/0128570 A1
(43) Pub. Date: May 24, 2012

(54) PROCESS FOR THE PREPARATION OF GRAPHITE OXIDE AND GRAPHENE SHEETS

(75) Inventors: Gautham Krishnaiah, Ellicott City, MD (US); Vipin Varma, Gent (BE)

(73) Assignee: Vorbeck Materials Corp., Jessup, MD (US)

(21) Appl. No.: 13/123,312

(22) PCT Filed: Oct. 10, 2009
(86) PCT No.: PCT/US09/60295

§ 371 Date: Sep. 2, 2011

Related U.S. Application Data
(60) Provisional application No. 61/104,715, filed on Oct. 11, 2008.

(51) Int. Cl. C01B 31/04; C01B 31/00; B82Y 40/00; B82Y 30/00

(52) U.S. Cl. 423/415.1; 423/448; 977/842; 977/734

(57) ABSTRACT

A process for the preparation of graphite oxide from graphite using a permanganate salt and an aqueous sulfuric acid solution. The graphite oxide may be further reacted to form graphene sheets.

### FIELD OF THE INVENTION

An improved process for the preparation of graphite oxide from graphite and the further transformation of graphite oxide into graphene sheets.

### BACKGROUND

Graphite oxide (also known as graphitic acid or graphene oxide) has many applications, including as a precursor to thermally exfoliated graphite oxide. See, for example, Schniepp, H. C. et al. J. Phys. Chem. B. 2006, 110, 8535-8539; Li et al. Phys. Rev. Lett. 2006, 96, 176101; McAllister, M. J. et al. Chem. Materials 2007 19, 4396-4404; Herrera-Alonso et al. Langmuir 2007, 23, 10644-10649; Kudin, N. K. et al. Nano Letters 2008, 8, 36-41; and U.S. patent application publication 2007/0092432, all of which are hereby incorporated by reference herein. The preparation of graphite oxide from graphite was first reported in the 19^{th} century. Staudenmaier (Ber. Stsch. Chem. Ges. 1898, 31, 1481) published a method using concentrated nitric acid, concentrated sulfuric acid, and potassium chlorate to effect the transformation. Though this method has been widely used in the subsequent 110 years, it has considerable drawbacks in that it requires the use of explosive and difficult to handle chlorates and concentrated acids, as well as having reaction times that can be as long as about a week.

U.S. Pat. No. 2,798,878 to Hummers and W. S. Hummers and R. E. Offeman, J. Am. Chem. Soc. 80, 1958, 1339 describe a method of preparing graphitic acid from graphite (the “Hummers method”) using an anhydrous mixture of a nitrate, a permanganate, and concentrated sulfuric acid. Though the explosion hazard is significantly reduced with this method and it has also been widely used since its introduction, the required use of anhydrous concentrated sulfuric acid has a number of disadvantages. For example, the sulfuric acid can be costly; its high viscosity can make the reaction mixture difficult to work with; and it can make temperature control of the reaction more difficult. Furthermore, high volumes of concentrated acids such as sulfuric acid can be difficult to neutralize and/or remove.

It would thus be desirable to obtain an efficient method of making graphite oxide that did not require the use of potentially explosive reagents or concentrated mineral acids.

### SUMMARY OF THE INVENTION

Disclosed and claimed herein is a method of preparing graphite oxide from graphite comprising the step of treating graphite with at least one permanganate salt in the presence of a solution comprising from about 55 to about 95 volume percent of sulfuric acid and about 5 to about 45 volume percent of water, wherein the volume percentages are based on the total volume of the solution.

Further disclosed and claimed herein is a method of preparing graphene sheets from graphite, comprising the steps of:
a. treating graphite with at least one permanganate salt in the presence of a solution comprising from about 55 to about 95 volume percent of sulfuric acid and about 5 to about 45 volume percent of water to form graphite oxide, wherein the volume percentages are based on the total volume of the solution to form graphite oxide; and
b. converting the graphite oxide to graphene sheets.

### DETAILED DESCRIPTION OF THE INVENTION

In the process of the present invention, graphite is treated with at least one permanganate salt in a solution comprising about 55 to about 95 volume percent sulfuric acid and about 5 to about 45 volume percent water, where the volume percentages are based on the total volume of the solution. The solution preferably comprises about 55 to about 90 volume percent sulfuric acid and about 10 to about 45 volume percent water, or more preferably about 60 to about 90 volume percent sulfuric acid and about 10 to about 40 volume percent water, or even more preferably about 70 to about 90 volume percent sulfuric acid and about 10 to about 30 volume percent water, again where the volume percentages are based on the total volume of the solution.

Examples of suitable permanganate salts include, but are not limited to, potassium permanganate, barium permanganate, sodium permanganate, calcium permanganate, and magnesium permanganate. Preferred permanganate salts are potassium permanganate and sodium permanganate.

In one embodiment of the invention, the permanganate salt to graphite molar ratio is preferably from about 0.1:1 to about 1:1, or more preferably from about 0.15:1 to about 0.5:1, or yet more preferably from about 0.15:1 to about 0.3:1.

The graphite used can be any suitable form of graphite, including natural graphite (including natural flake graphite), Kish graphite, highly oriented pyrolytic graphite, synthetic graphite, graphitic materials such as graphitic carbon fibers (including those derived from polymers), and the like. There is no particular limitation to the particle size of the graphite used. Longer reaction times may be needed when larger particle-sized graphite is used.

In one embodiment of the invention, the graphite is first suspended in a stirred water/sulfuric acid solution and the permanganate salt is then added. In a preferred embodiment of the invention, the temperature of the reaction mixture does not exceed about 95° C. In another preferred embodiment, the temperature of the reaction mixture reaches about 55 to about 90° C., or more preferably about 65 to about 90° C. at its highest point. In one embodiment of the invention, the reaction time is about 1.5 to about 2.5 hours. The reaction time may depend on the particle size of the graphite used. Larger graphite particle sizes may require longer reaction times.

The graphite oxide prepared by the method of the invention preferably has a carbon to oxygen molar ratio (referred to herein as the graphite oxide “C/O ratio”) of from about 1 to about 3. C/O ratios are measured using elemental analysis.

The degree of conversion of graphite to graphite oxide can be determined by X-ray diffraction (XRD) by comparing the graphite peak at a 2θ of about 25 to about 30° and the graphite oxide peak at a 2θ of about 10 to about 15°. It is preferred that the graphite is at least about 80% converted to graphite oxide, or more preferred that the graphite is at least about 90% converted to graphite oxide, or yet more preferred that the graphite is at least about 95% converted to graphite oxide, or even more preferred that the graphite is at least about 98% converted to graphite oxide, wherein the conversion percentages can be measured using XRD pattern peaks calibrated for absolute scattering intensities.

The graphite oxide prepared by the method of the present invention may be used in a variety of applications, including, for example, as a filler in polymeric composites; a component in an ultracapacitor, battery, or other electrochemical storage device; a hydrogen storage device; and the like.

The graphite oxide may be converted into graphene sheets. The graphene sheets are graphite sheets preferably having a surface area of from about 100 to about 2630 m²/g. In some embodiments of the present invention, the graphene sheets primarily, almost completely, or completely comprise fully exfoliated single sheets of graphite (these are approximately 1 nm thick and are often referred to as “graphene”), while in other embodiments, they may comprise partially exfoliated graphite sheets, in which two or more sheets of graphite have not been exfoliated from each other. The graphene sheets may comprise mixtures of fully and partially exfoliated graphite sheets.

The graphene sheets may be formed by exfoliating the graphite oxide by heating to form high surface area graphene sheets that are in the form of thermally exfoliated graphite oxide, using a procedure such as that described in U.S. 2007/0092432, the disclosure of which is hereby incorporated herein by reference. The thusly formed thermally exfoliated graphite oxide may display little or no signature corresponding to graphite or graphite oxide in its X-ray diffraction pattern.

Heating can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. vessel.

During heating, the graphite oxide may be contained in an essentially constant location in single batch reaction vessel, or may be transported through one or more vessels during the reaction in a continuous or batch mode. Heating may be done using any suitable means, including the use of furnaces and infrared heaters.

The temperature used is preferably at least about 750° C., or more preferably at least about 850° C., or yet more preferably at least about 950° C., or still more preferably at least about 850° C. at least about 1000° C. The temperature used is preferably between about 750 about and 3000° C., or more preferably between about 850 and 2500° C., or yet more preferably between about 950 and about 2500° C. The time of heating can range from less than a second to many minutes. In one embodiment of the invention, the time of heating is less than about 10 seconds. In another, the time of heating is preferably at least about 2 minutes, or more preferably at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of heating, the temperature may vary.

Alternatively, the graphite oxide may be reduced chemically. Examples of useful reducing agents include, but are not limited to, hydrazines (such as hydrazine, N,N-dimethylhydrazine, etc.), sodium borohydride, hydroquinone, isocyanates (such as phenyl isocyanate), hydrogen, hydrogen plasma, etc. A dispersion or suspension of exfoliated graphite oxide in a carrier (such as water, organic solvents, a mixture of solvents, etc.) can be made using any suitable method (such as ultrasonication and/or mechanical grinding or milling) and reduced to graphene sheets. A graphite oxide suspension may be cast or otherwise placed on a surface and the solvent fully or partially removed and the remaining graphite oxide chemically reduced.

The graphene sheets preferably have a surface area of from about 50 to about 2630 m²/g, or of from about 100 to about 2630 m²/g, or of from about 200 to about 2630 m²/g, of from about 300 to about 2630 m²/g, or of from about 350 to about 2630 m²/g, or of from about 400 to about 2630 m²/g, or of from about 500 to about 2630 m²/g, or of from about 600 to about 2630 m²/g, or of from about 700 to about 2630 m²/g. In another embodiment, the surface area is about 300 to about 1100 m²/g. A single graphite sheet has a maximum calculated surface area of 2630 m²/g. The surface area includes all values and subvalues therebetween, especially including 400, 450, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets preferably have number average aspect ratios of about 100 to 100,000 (where “aspect ratio” is defined as the ratio of the longest dimension of the sheet to the shortest).

Surface area can be measured using either the nitrogen adsorption/BET method or, preferably, a methylene blue (MB) dye method in liquid solution.

The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations.

The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets preferably have a bulk density of from about 0.1 to at least about 200 kg/m³. The bulk density includes all values and subvalues therebetween, especially including 0.5, 1, 5, 10, 15, 20, 25, 30, 35, 50, 75, 100, 125, 150, and 175 kg/m³.

The graphene sheets may be functionalized with, for example, oxygen-containing functional groups (including, for example, hydroxyl, carboxyl, and epoxy groups) and typically have an overall carbon to oxygen molar ratio (C/O ratio), as determined by elemental analysis of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1. In some embodiments of the invention, the carbon to oxygen ratio is at least about 10:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets may contain atomic scale kinks due to the presence of lattice defects in the honey comb structure of the graphite basal plane. These kinks can be desirable to prevent the stacking of the single sheets back to graphite oxide and/or other graphite structures under the influence of van der Waals forces.

### EXAMPLES

The graphite used in the examples and comparative examples is natural flake graphite 230 supplied by Asbury Carbons (Asbury, N.J.).

### Comparative Examples 1 and 4

The quantities of the reactants used are given in Table 1. Concentrated sulfuric acid is added to a 4000 mL beaker cooled in an ice bath. The reaction mixture is stirred throughout the reaction. Graphite is added to the beaker and stirring is continued for about 5 to 7 minutes with continued cooling in an ice bath. Sodium nitrate is then added to the reaction mixture. Potassium permanganate is added over about two minutes. The temperature of the reaction mixture at the end of the graphite addition is given in Table 1 under the heading “T₀”. The reaction is allowed to proceed for about 90 minutes and the maximum observed temperature reached by the reaction mixture is given in Table 1 under the heading “Tₘₐₓ”.

At the end of the reaction the mixture is transferred into another beaker containing ˜2000 mL of deionized water. 400 mL of concentrated (37.5%) HCl is added to the mixture with constant stirring. The mixture is topped off to a total volume of 4000 ml using deionized water and stirred for about 60 minutes. The mixing is discontinued after 60 minutes and the solids are allowed to settle for at least about 8 hrs.

The product is then washed as follows: After the solids settle adequately the supernatant solution is decanted and the mixture is again topped off to a total volume of about 4000 ml with deionized water. The mixture is again stirred for about 60 minutes followed by settling for at least about 8 hrs. This is the second washing stage. The mixture is then washed with 400 mL of concentrated (37.5%) HCl. The mixture is then washed with water and decanted, as described above, until the pH of the supernatant solution reaches about 6.

### Comparative Examples 2 and 3

The quantities of the reactants used are given in Table 1. Fuming nitric acid (90%) is added to a 2000 mL beaker cooled in an ice bath. Concentrated sulfuric acid is slowly added to the nitric acid. The temperature of the reaction mixture reaches about 30°. Graphite is then added to the mixture, followed by potassium permanganate. The temperature of the reaction mixture at the end of the addition of graphite is given in Table 1 under the heading “T₀”. The reaction is allowed to proceed for about 90 minutes and the maximum observed temperature reached by the reaction mixture is given in Table 1 under the heading “Tₘₐₓ”.

At the end of the reaction, deionized water (3000 mL) is combined with the reaction mixture, followed by the addition of 400 mL of concentrated (37.5%) HCl. The resulting mixture is stirred for about 60 minutes and then the suspended solids are allowed to settle. The reaction product is then washed as described above for Comparative Examples 1 and 4.

### Comparative Example 5

The quantities of the reactants used are given in Table 1. Deionized water is added to a 4000 mL beaker cooled in an ice bath. Concentrated sulfuric acid is then slowly added to the water. The reaction mixture is stirred throughout the reaction. Graphite is added to the beaker over about 15 minutes with continued cooling in an ice bath. Potassium permanganate is added over about one to two minutes. The temperature of the reaction mixture at the end of the graphite addition is given in Table 1 under the heading “T₀”. The reaction is allowed to proceed for about 90 minutes and the maximum observed temperature reached by the reaction mixture is given in Table 1 under the heading “Tₘₐₓ”.

At the end of the reaction, the reaction mixture is added to deionized water (2000 mL), followed by the addition of 400 mL of concentrated (37.5%) HCl. The resulting mixture is stirred for about 60 minutes. The reaction product is then washed as described above for Comparative Examples 1 and 4.

### Comparative Examples 6 and 8

The quantities of the reactants used are given in Table 2. Concentrated sulfuric acid is added to a 4000 mL beaker cooled in an ice bath. Graphite is then added to the mixture, which is then stirred for about 30 minutes. The graphite/sulfuric acid mixture is then added to deionized water. Potassium permanganate is then added to the mixture. The temperature of the reaction mixture before the addition of potassium permanganate is given in Table 2 under the heading “T₀”. The reaction is allowed to proceed for about 90 minutes and the maximum observed temperature reached by the reaction mixture is given in Table 2 under the heading “Tₘₐₓ”.

At the end of the reaction, the reaction mixture is combined with deionized water (1250 mL for Comparative Example 6 and 1400 mL for Comparative Example 8). The mixture is then stirred for about 30 minutes and 400 mL of concentrated (37.5%) HCl is added. The resulting mixture is then stirred for about 30 minutes. The reaction product is then washed as described above for Comparative Examples 1 and 4.

### Comparative Examples 7 and 9

The quantities of the reactants used are given in Table 2. Deionized water is added to a 4000 mL beaker cooled in an ice bath. Concentrated sulfuric acid then slowly added to the water and the resulting mixture is cooled to about 30-35° C. Graphite is added to the beaker over about 10 to 15 minutes while maintaining the temperature about 30-35° C. The total reaction times are given in Table 2. The maximum observed temperature reached by each reaction mixture is given in Table 2 under the heading “Tₘₐₓ”.

At the end of the reaction, the reaction mixture is combined with deionized water (1675 mL), followed by 400 mL of concentrated (37.5%) HCl. The resulting mixture is stirred for about 60 minutes. The reaction product is then washed as described above for Comparative Examples 1 and 4.

### Examples 1 to 3

The quantities of the reactants used are given in Table 3. Deionized water is added to a 4000 mL beaker cooled in an ice bath. Concentrated sulfuric acid then slowly added to the water and the resulting mixture is cooled to about 30-35° C. Graphite is added to the beaker over about 10 to 15 minutes while maintaining the temperature about 20-25° C. The total reaction times are given in Table 3. The maximum observed temperature reached by each reaction mixture is given in Table 3 under the heading “Tₘₐₓ”.

At the end of the reaction, the reaction mixture is combined with deionized water (1650 mL), followed by 400 mL of concentrated (37.5%) HCl. The resulting mixture is stirred for about 60 minutes. The reaction product is then washed as described above for Comparative Examples 1 and 4.

### Carbon to Oxygen Molar Ratios

Carbon to oxygen molar ratios (abbreviated as “C:O ratio”) are determined by elemental analysis and the results are shown in the tables.

### X-Ray Diffraction Measurements

X-ray diffraction patterns are acquired for the reaction product of each example and comparative example. The degree of conversion of graphite to graphite oxide can be determined by comparing the graphite peak at a 20 of about 25 to about 30° and the graphite oxide peak at a 20 of about 10 to about 15°. The results are given in the tables. Where the graphite oxide peak is weak and accompanied by a noisy baseline, the results is described as “weak GO peak”. Where the graphite oxide peak is strong, the result is described as “strong GO peak.” Where only the peak corresponding to graphite is observed, the result is described as “graphite only”.

### Exfoliation Procedure

The graphite oxide of the examples and comparative examples is thermally exfoliated to form graphene sheets by passing it through a silica tube in an argon stream. The tube is heated with an infrared heater at about 1040° C.

### Surface Area Measurement Procedure

The surface areas of the graphene sheets produced by the exfoliation reaction for Comparative Examples 1 and 5 are measured using the B.E.T. technique in a Quantachrome Nova 2200e surface area analyzer. Powder samples are degassed under vacuum at 300° C. for at least 4 hours. Surface areas are determined by five point nitrogen adsorption measurements. The results are given in Table 1. In some cases multiple measurements are performed and the average of these is reported in the tables. In such cases, the number of measurements is also indicated.

TABLE 1

| | CE 1 | CE 2 | CE 3 | CE 4 | CE 5 |
|---|---|---|---|---|---|
| Sodium nitrate (g) | 20 | — | — | 10 | — |
| Nitric acid (mL) | — | 25 | 25 | — | — |
| Sulfuric acid (mL) | 1200 | 920 | 920 | 600 | 1200 |
| Water (mL) | — | — | — | — | — |
| Potassium permanganate (g) | 120 | 120 | 130 | 60 | 120 |
| Graphite (g) | 40 | 40 | 40 | 20 | 40 |
| Reaction time (min) | 90 | 90 | 90 | 90 | 90 |
| T₀ (° C.) | 24 | | 18 | 24 | 25 |
| Tₘₐₓ (° C.) | 85 | 95 | >110 | | 85 |
| C:O ratio of graphite oxide | 1.5 | — | — | 1.3 | — |
| C:O ratio of graphene sheets | 7.7 | — | — | 21.3 | — |
| Surface area (m²/g) [number | 544 [3] | | | | 662 [1] |
| of measurements] | | | | | |
| XRD results | Weak | Weak | Weak | Weak | Weak |
| | GO | GO | GO | GO | GO |
| | peak | peak | peak | peak | peak |

TABLE 2

| | CE 6 | CE 7 | CE 8 | CE 9 |
|---|---|---|---|---|
| Sulfuric acid (mL) | 500 | 600 | 500 | 120 |
| Water (mL) | 400 | 600 | 700 | 1000 |
| Water (vol. %) | 44.4 | 50 | 58.3 | 89.3 |
| Potassium permanganate (g) | 120 | 120 | 120 | 120 |
| Graphite (g) | 40 | 40 | 40.5 | 40 |
| Pre-intercalation time (min) | 0 | 0 | 30 | 0 |
| Reaction time (min) | 90 | 150 | 90 | 90 |
| T₀ (° C.) | 39 | | 25 | |
| Tₘₐₓ (° C.) | 82 | 85 | 55 | 77 |
| C:O ratio of graphite oxide | | 17.6 | | |
| XRD results | | Graphite | Graphite | Graphite |
| | | only | only | only |

TABLE 3

| | Ex. 1 | Ex. 2 | Ex. 3 |
|---|---|---|---|
| Sulfuric acid (mL) | 1200 | 900 | 600 |
| Water (mL) | 350 | 265 | 265 |
| Water (vol. %) | 22.6 | 22.7 | 30.6 |
| Potassium permanganate (g) | 120 | 120 | 120 |
| Graphite (g) | 40 | 40 | 40 |
| Pre-intercalation time (min) | 0 | 0 | 0 |
| Reaction time (min) | 150 | 90 | 90 |
| T₀ (° C.) | 25-30 | 25-30 | 35 |
| T_{f} (° C.) | 66 | 70 | 85 |
| C:O ratio of graphite oxide | 1.7 | 1.7 | |
| C:O ratio of graphene sheets | 16.7 | 13.4 | |
| XRD results | Strong GO | Strong GO | Strong GO |
| | peak | peak | peak; small |
| | | | graphite peak |

1. A method of preparing graphite oxide from graphite comprising the step of treating graphite with at least one permanganate salt in the presence of a solution comprising from about 55 to about 95 volume percent of sulfuric acid and about 5 to about 45 volume percent of water, wherein the volume percentages are based on the total volume of the solution.

2. The method of claim 1, wherein the solution comprises from about 55 to about 90 volume percent of sulfuric acid and about 10 to about 45 volume percent of water.

3. The method of claim 1, wherein the solution comprises from about 60 to about 90 volume percent of sulfuric acid and about 10 to about 40 volume percent of water.

4. The method of claim 1, wherein the solution comprises from about 70 to about 90 volume percent of sulfuric acid and about 10 to about 30 volume percent of water.

5. The method of claim 1, wherein the permanganate salt is one or more of potassium permanganate and sodium permanganate.

6. The method of claim 1, wherein the permanganate salt is potassium permanganate

7. The method of claim 1, wherein the graphite oxide has a carbon to oxygen molar ratio of from about 1:1 to about 3:1.

8. Graphite oxide prepared by the method of claim 1.

9. A method of preparing graphene sheets from graphite, comprising the steps of:
a. treating graphite with at least one permanganate salt in the presence of a solution comprising from about 55 to about 95 volume percent of sulfuric acid and about 5 to about 45 volume percent of water to form graphite oxide, wherein the volume percentages are based on the total volume of the solution to form graphite oxide; and
b. converting the graphite oxide to graphene sheets.

10. The process of claim 9, wherein the graphite oxide is converted to graphene sheets by heating.

11. The method of claim 9, wherein the graphite oxide is converted to graphene by chemical reduction.

12. The method of claim 11, wherein the chemical reduction is carried out using hydrazine.

13. The method of claim 9, wherein the graphene sheets have a carbon to oxygen molar ratio of about 3:2 to about 1000:1.

14. The method claim 9, wherein the graphene sheets have a carbon to oxygen molar ratio of at least about 10:1.

15. The method of claim 9, wherein the graphene sheets have a carbon to oxygen molar ratio of at least about 20:1.

16. The method of claim 9, wherein the graphene sheets have a bulk density of from about 0.1 to at least about 200 kg/m³.

17. The method of claim 9, wherein the graphene sheets have a surface area of from about 100 to about 2630 m²/g.

18. The method of claim 9, wherein the graphene sheets have a surface area of from about 300 to about 2630 m²/g.

19. The method of claim 9, wherein the graphene sheets have a surface area of from about 450 to about 2630 m²/g.

20. The method of claim 9, wherein the graphene sheets have a surface area of from about 600 to about 2630 m²/g

21. Thermally exfoliated graphite oxide prepared by the method of claim 9.
